(19) United States
(12) Patent Application Publication
(10) Pub. No.: US 2011/0081033 A1
(43) Pub. Date: Apr. 7, 2011

(54) METHOD FOR ADJUSTING AN AUDIO TRANSDUCING PROCESSOR

(75) Inventor: Shigeyoshi Kitazawa, Shizuoka (JP)

(73) Assignee: HAMAMATSU FOUNDATION FOR SCIENCE AND TECHNOLOGY PROMOTION, Shizuoka (JP)

(21) Appl. No.: 12/877,066

(22) Filed: Sep. 7, 2010

Related U.S. Application Data
(63) Continuation of application No. PCT/JP2009/001003, filed on Mar. 5, 2009.

(30) Foreign Application Priority Data
Mar. 7, 2008 (JP) JP2008-058566

(51) Int. Cl. H04R 25/00

(52) U.S. Cl. 381/321

(57) ABSTRACT

An audio transducing processor can be adjusted under conditions based on the subjectivity of an actual wearer and can improve the wearer's comfort. A method for adjusting an audio transducing processor provided with a cochlear implant for augmenting audition by giving audio information as stimulus pulses to a cochlea of a wearer can comprise an audiometry step for finding an audible sound range of the wearer using frequency and sound pressure as variables, and adjusting the audio transducing processor on the basis of hearing acuity data obtained from the audiometry step.

### CROSS-REFERENCE TO RELATED APPLICATIONS

This application is a continuation of International Application No. PCT/JP2009/001003, filed Mar. 5, 2009, which claims the benefit of priority from Japanese Application No. 2008-058566, filed Mar. 7, 2008; all of which are incorporated by reference herein in their entireties.

### FIELD OF THE DISCLOSURE

The present invention relates to methods for adjusting an audio transducing processor provided with a cochlear implant for augmenting audition (i.e. hearing sensation) by delivering audio information as stimulus pulses to a cochlea of a wearer.

### BACKGROUND

The cochlear implant is a medical instrument in which fine electrodes are implanted in a cochlea of an inner ear by surgery for electrically stimulating the auditory nerve and transmitting the electric stimulation to a brain so that a person who has lost his (or her) audition due to physical troubles of the inner ear can recover the audition and mainly comprises a microphone, an audio transducing processor, stimulus electrodes and a wireless transmitter/receiver. Audition is augmented by generating electrical stimulus pulses by sending audio information in each channel to an electrode corresponding to the channel and then by giving the audio information as stimulus pulses.

Various types of cochlear implants such as ACE type have been proposed and an applicant of this application has also proposed a cochlear implant of CSPE type (multi-type) such as shown in International Patent Application Publication WO 2005/013870. In those cochlear implants the adjustment of the audio transducing processor is determined mainly by a minimum audible threshold (T-level) and a maximum comfortable threshold (C-level) of a wearer. That is, the audio transducing processor is adjusted by setting the minimum audible threshold (T-level) and the maximum comfortable threshold (C-level) by supplying electric current to the cochlear implant of a wearer and confirming his response.

### SUMMARY OF THE DISCLOSURE

In prior art adjustment methods, the minimum audible threshold (T-level) and the maximum comfortable threshold (C-level) of a wearer are set by current fed to the cochlear implant. Those conditions are not optimal for adjustment to the audition for an actual wearer. Therefore, adjustment to an actual wearer can be improved. Prior art methods for adjustment of the audio transducing processor often would not be optimum even though the processor has been adjusted in an electrically best-fitted manner. Electrical adjustment of a CSPE-type cochlear implant is especially difficult because of characteristics of the analytic algorithm.

An audio transducing processor is preferably adjusted under conditions based on the subjectivity of an actual wearer and can improve a wearer's comfort.

A method for adjusting an audio transducing processor provided with a cochlear implant for augmenting audition by giving audio information as stimulus pulses to a cochlea of a wearer can comprise an audiometry step for finding an audible audio range of the wearer using a frequency and a sound pressure as variables, and adjustment of the audio transducing processor on the basis of hearing acuity data obtained from the audiometry step.

Preferably, in some embodiments, the audio transducing processor adjusts the minimum audible threshold and the maximum comfortable threshold so that they are included within a frequency/sound pressure level necessary for audio perception or speech perception.

Preferably, in some embodiments, the minimum audible threshold is an equal loudness level of about 40 phon and the maximum comfortable threshold is an equal loudness level of about 70 phon.

In contrast to prior art methods of setting a minimum audible threshold (T-level) and the maximum comfortable threshold (C-level) of a wearer by current fed to the cochlear implant, the disclosed methods for adjusting an audio transducing processor can be based on the subjective preferences of an actual wearer and can improve the wearer's comfort since the disclosed methods can comprise an audiometry step for finding an audible audio range of the wearer using a frequency and a sound pressure as variables, and adjustment of the audio transducing processor on the basis of hearing acuity data obtained from the audiometry step.

### BRIEF DESCRIPTION OF THE DRAWINGS

Additional advantages and features will become apparent from the subsequent description and the appended claims, taken in conjunction with the accompanying drawings, wherein:

FIG. 1 is a schematic view illustrating a cochlear implant to which embodiments of the present invention can be applied;

FIG. 2 is a graph illustrating a relationship between loudness and variation in a method for adjusting an audio transducing processor according to an embodiment of the present invention;

FIG. 3 is a flowchart illustrating a method for adjusting an audio transducing processor according to an embodiment of the present invention;

FIG. 4 is a graph illustrating a condition before loudness adjustment according to a method for adjusting an audio transducing processor according to an embodiment of the present invention;

FIG. 5 is a graph illustrating a condition after loudness adjustment according to a method for adjusting an audio transducing processor according to an embodiment of the present invention;

FIG. 6 is a graph illustrating results of an experiment applying a method for adjusting an audio transducing processor according to an embodiment of the present invention to a wearer “A” with a CSPE-type implant;

FIG. 7 is a graph illustrating results of an experiment applying a method for adjusting an audio transducing processor according to an embodiment of the present invention to the wearer “A” with an ACE-type implant;

FIG. 8 is a graph illustrating results of an experiment applying a method for adjusting an audio transducing processor according to an embodiment of the present invention to a wearer “B” with a CSPE-type implant; and

FIG. 9 is a graph illustrating results of an experiment applying a method for adjusting an audio transducing processor according to an embodiment of the present invention to the wearer “B” with an ACE-type implant.

### DETAILED DESCRIPTION OF THE PREFERRED EMBODIMENTS

Preferred embodiments of the present invention will be described with reference to the accompanying drawings.

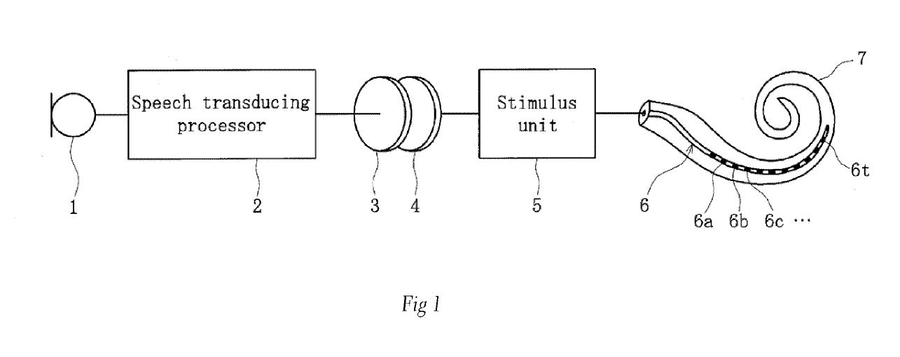

A cochlear implant to which embodiments of the present invention can be applied is used for augmenting audition by delivering audio information as stimulus pulse to a cochlea of a wearer and can comprise, as shown in FIG. 1, a microphone 1 for picking up outside audio as electric signals, an audio transducing processor 2 for performing audio processing in accordance with a program to transduce the audio information sampled via the microphone 1 to stimulus pulses, an outside coil 3 forming an antenna outside of a wearer's body, an inside coil 4 forming an antenna inside of a wearer's body, a stimulus unit 5 for transducing the audio information sent from the audio transducing processor 2 to electric stimulus pulses via the outside coil 3 and the inside coil 4, and an electrode array 6 arranged in a cochlea 7 of the wearer and including a plurality of electrodes 6a-6t (e.g., 20 electrodes in the illustrated embodiment) for actually outputting the stimulus pulses. Ends of auditory nerves are stimulated by electric currents supplied by the electrodes 6a-6t and thus the wearer can perceive the current stimulation as sound, e.g., speech.

The cochlear implant described above is a medical instrument in which the electrodes 6a-6t are implanted by surgery in the cochlea of a wearer who has lost his audition due to physical troubles of the inner ear so as to electrically stimulate the auditory nerve by the stimulus unit 5 via the microphone 1 through the inside coil 4 and to reduce the wearer's difficulty with audition. The audio transducing processor 2 can determine which electrode should be stimulated from an audio wave form inputted from the microphone 1 and plays a role of a physical cochlea.

The wearer cannot expect the cochlear implant to function perfectly immediately after the implantation surgery. Rather, further steps must be carried out after the surgery, such as measuring optimum amount of electric current of the electrodes 6a-6t and setting a program providing the wearer with most clear sound (e.g., speech), a process referred to as “mapping.” Mapping enables the wearer to perceive the sound (e.g., speech). However, an adjustment (“fitting”) of the audio transducing processor is further performed so that the wearer perceives sound more clearly.

Methods according to embodiments of the present invention can comprise an audiometry step for finding an audible sound range, or audible speech range, of the wearer using frequency and sound pressure as variables, and adjustment of the audio transducing processor based on hearing acuity data obtained from the audiometry step. More particularly, the audiometry step of the present invention is to find the actually audible sound range of the wearer using frequency and sound pressure as variables (i.e. performed by an “acoustic” manner) in place of the method of the prior art in which the minimum audible threshold (T-level) and the maximum comfortable threshold (C-level) of a wearer are set by current fed to the cochlear implant.

In the description in the present specification, the minimum audible threshold (T-level) is defined as a sound pressure level at which a wearer can perceive speech (sound), and on the other hand the maximum comfortable threshold (C-level) is defined as a maximum sound pressure level at which a wearer can hear speech (sound) without any discomfort. Usually, the minimum audible threshold (T-level) and the maximum comfortable threshold (C-level) are determined by an amount of electric current (μA). However, in embodiments of the present invention, the minimum audible threshold (T-level) and the maximum comfortable threshold (C-level) are measured by an acoustic manner and defined by decibel (dB).

The audiometry step can be performed by a sound pressure increment audiometry method. In some embodiments, the audiometry can be performed in twenty (20) frequency ranges corresponding to the number of the electrodes in the cochlear implant using a warble tone, for example, increasing every 5 (dB) in a sound pressure range from 20 (dB) to 80 (dB). The acoustic minimum audible threshold (T-level) and the maximum comfortable threshold (C-level) of a wearer can be determined in accordance with two signals from the wearer: first, at a point of time when he can perceive the sound and, second, at a point of time when he can hear maximum sound without any discomfort.

The adjustment of the audio transducing processor 2 is performed by changing the mapping function (gain and non-linear compressibility function at each channel) of the audio transducing processor 2 on the basis of the acoustic hearing acuity data (the minimum audible threshold (T-level) and the maximum comfortable threshold (C-level)) obtained in the audiometry step, described above. More particularly, since it is desirable for the cochlear implant to be configured such that that the minimum audible threshold (T-level) and the maximum comfortable threshold (C-level) are equally loud, the acoustic minimum audible threshold (T-level) and the maximum comfortable threshold (C-level) of a wearer are adjusted in accordance with target values on the equal loudness curve.

In this context, loudness is a magnitude of sound defined by an amount of sensation corresponding to the strength of the sound, and the equal loudness curve is formed by connecting plots of sound pressure level of frequencies felt as having same magnitude as said sound as the basis for the sound pressure level of a pure tone of 1000 (Hz). For example, a curve corresponding to 1000 (Hz) and 40 (dB) is defined as an equal loudness curve of 40 phon. In the illustrated embodiment of the present invention, equal loudness portions in twenty (20) frequency portions corresponding to the electrodes of the cochlear implant were determined.

The measured value (T/C level) and the adjusting amount are measured in decibels (dB). The adjusting amount is calculated based on the decibel (dB) increase or decrease to make the minimum audible threshold (T-level) and the maximum comfortable threshold (C-level) in each electrode (channel) equally loud. This adjusting amount is obtained by adjustment of gain of band pass filters corresponding to each channel and the adjusting amount (in a case of a twenty (20) channel filter) can be obtained from a following operation:

(adjusting amount)=(output of each filter)×(gain adjustment factor(A))

wherein the gain adjustment factor (A)=10((T−L)/20), and “T” is a value (dB) of the measured minimum audible threshold (T-level), and “L” is a level (dB) of the equal loudness.

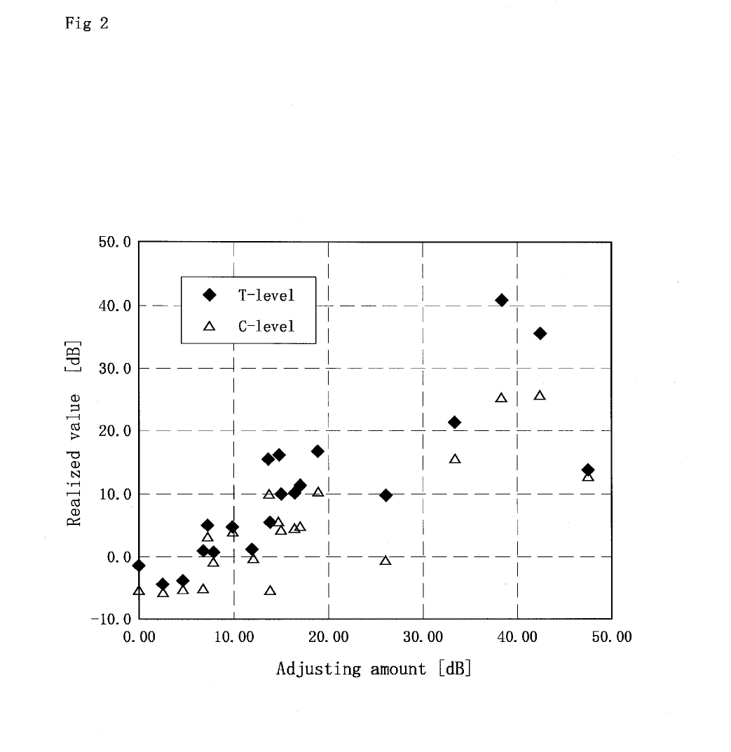

The amount of variation (i.e. loudness variation) by this adjustment amount of the minimum audible threshold (T-level) and the maximum comfortable threshold (C-level) is expressed by a decibel (dB) increase or decrease. FIG. 2 plots the adjustment results of the wearer of a cochlear implant and shows that the calculating method is effective. In FIG. 2, the abscissa is an adjusting amount (=−20 log(A)), ordinates is realized value (=T level (C level) after adjustment−T level (C level) before adjustment), and each point exhibits the loudness variation. These results demonstrate that the calculated adjusting amount and the realized loudness variation are in a proportional relation.

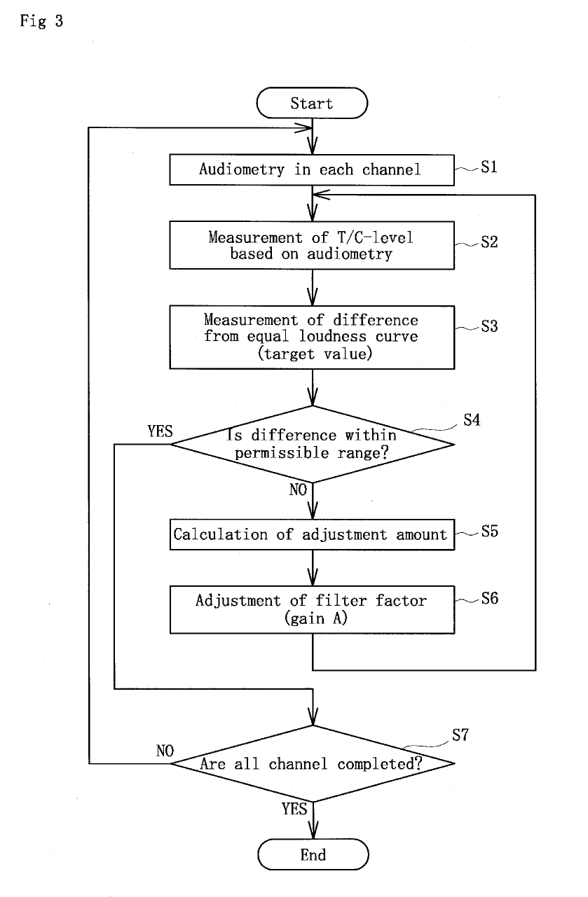

However, since the effect in each channel is different due to unknown factors, it is preferable to perform the audiometry again and to further perform the re-adjustment on the basis of the results of measurement. A flowchart of FIG. 3 will be described in relation to the re-adjustment. At the outset, the audiometry is performed in each channel (S1). Then the minimum audible threshold (T-level) and the maximum comfortable threshold (C-level) are measured based on the audiometry (S2).

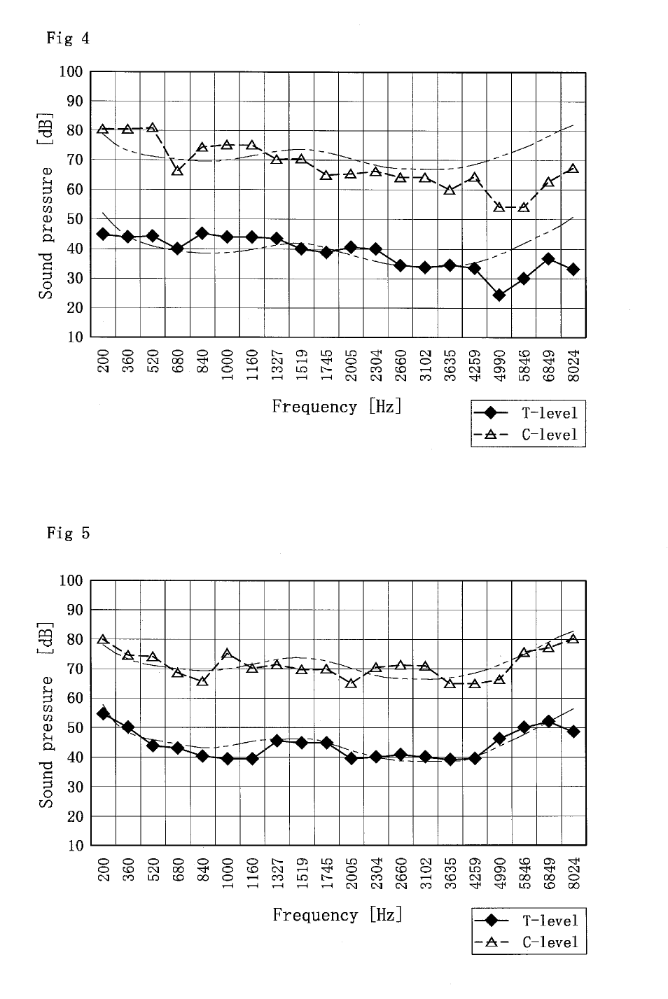

The difference from the equal loudness curve (target value) is measured (S3). Then whether or not the difference is within permissible range is judged (S4). If it is “NO”, a calculation of the adjusting amount is performed (S5), and the filter factor (gain A) is adjusted (S6), and then returned to the step (S2) to measure the minimum audible threshold (T-level) and the maximum comfortable threshold (C-level) based on the audiometry. On the contrary if it is judged “YES” in step (S4), whether or not all the channels are completed is judged (S7). If it is judged “YES”, the re-adjustment procedure is ended. On the contrary if it is judged “NO”, returned again to the step (S1) and the adjusting step relating to a next channel is started. The characteristics of FIG. 4 can changed to that of FIG. 5 according to the loudness adjustment method of FIG. 3. In FIGS. 4 and 5, a two-dot chain line indicates the equal loudness curve and it will be understood that both the minimum audible threshold (T-level) and the maximum comfortable threshold (C-level) deviate from the equal loudness curve (two-dot chain line) in FIG. 4 and, on the contrary, both the minimum audible threshold (T-level) and the maximum comfortable threshold (C-level) substantially correspond to the equal loudness curve in FIG. 5.

Usually, the difference (width) between the minimum audible threshold (T-level) and the maximum comfortable threshold (C-level) is called a “dynamic range.” A dynamic range of about 30 (dB) is preferable for the cochlear implant. If identical cochlear implant were worn by several individuals, not all would be sure to have the preferred 30 (dB) dynamic range. However, the dynamic range can be expended by adjusting the correspondence with the nonlinear function between the minimum audible threshold (T-level) and the maximum comfortable threshold (C-level).

Further, according to some embodiments of the present invention, the minimum audible threshold and the maximum comfortable threshold of a wearer can be adjusted in the audio transducing processor so as to be within a frequency/sound pressure level range necessary for audio perception or speech perception. The “frequency/sound pressure level range necessary for speech perception” is exhibited by a graph having the abscissa of frequency (Hz) and the ordinates of sound pressure (dB) and sometimes referred to as a “Speech Banana” from its configuration.

The “frequency/sound pressure level range necessary for speech perception” (Speech Banana) can be divided to four (4) components, i.e. fundamental frequencies, vowel (except the fundamental frequencies), main consonants, and high tone consonants. The fundamental frequencies exhibit a pitch (height of tone) of human speech and are distributed near 120-225 (Hz) in a range of man and woman's height of speech tone. The vowel is distributed in a middle frequency zone and high sound pressure portion, general consonants are in a middle frequency zone and low sound pressure portion, and high tone consonants are in high frequency portion.

In the audio transducing processor 2, since the minimum audible threshold and the maximum comfortable threshold of a wearer are adjusted so that they are within a range of frequency/sound pressure level necessary for speech perception (within the Speech Banana), it is possible to suitably fit the minimum audible threshold and the maximum comfortable threshold of a wearer for speech perception, and to improve the wearer's comfort and accuracy listening to words. According to the preferred embodiment of the present invention, the minimum audible threshold (T-level) is set at about 40 phon equal loudness level, and the maximum comfortable threshold (C-level) is set at about 70 phon equal loudness level so as to suitably fit them for speech perception.

In contrast to prior art methods of setting a minimum audible threshold (T-level) and the maximum comfortable threshold (C-level) of a wearer by current fed to the cochlear implant, the disclosed methods for adjusting an audio transducing processor can be based on the subjective preferences of an actual wearer and can improve the wearer's comfort since the disclosed methods can comprise an audiometry step for finding an audible audio range of the wearer using a frequency and a sound pressure as variables, and adjustment of the audio transducing processor on the basis of hearing acuity data obtained from the audiometry step.

The results of experiments showing advantages of the present invention are described below.

The experiments were performed by providing two types of cochlear implants, i.e., the CSPE type and the ACE type, providing an audiometry step finding an audible sound range of two wearers, wearers “A” and “B”, using the frequency and the sound pressure as variables, and by adjusting the audio transducing processor based on hearing acuity data obtained by the audiometry step.

The CSPE-type cochlear implant is structured so that it selects frequencies having large amplitudes of wave forms of sound inputted from a microphone in each frame of 3-10 (ms) and stimulates electrodes corresponding to the selected frequencies. Thus, the number of stimulus electrodes per one frame is varied. In addition the stimulating rate of one electrode is variable and, for example, the maximum value of the stimulating rate per one electrode is 900-1800 (pps), and the total stimulating rate per one frame is 7200 (pps).

The ACE-type cochlear implant is structured so that it performs the FFT with 2 (ms) overlap as to 8 (ms) frame wave forms inputted from a microphone and selects frequency having a larger power and stimulates an electrode corresponding to the selected frequency. In this case, at least six (6) electrodes and at most twelve (12) electrodes are selected from twenty two (22) stimulus electrodes per one frame and a constant number of electrodes are stimulated in each wearer. Since the same number of electrodes are always stimulated, even a frequency region of weak stimulation must be selected. The stimulating rate of one electrode is variable and the maximum stimulating rate is 2400 (pps), and the total stimulating rate per one frame is 7200 (pps). The stimulation is performed by the electrodes from the bottom of the cochlea to the top thereof in order.

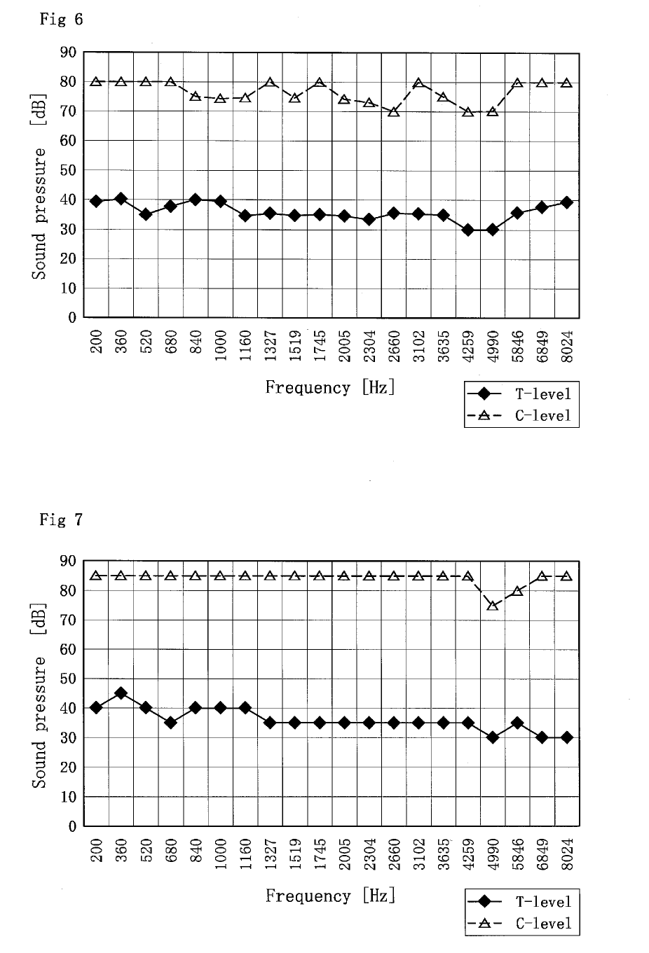

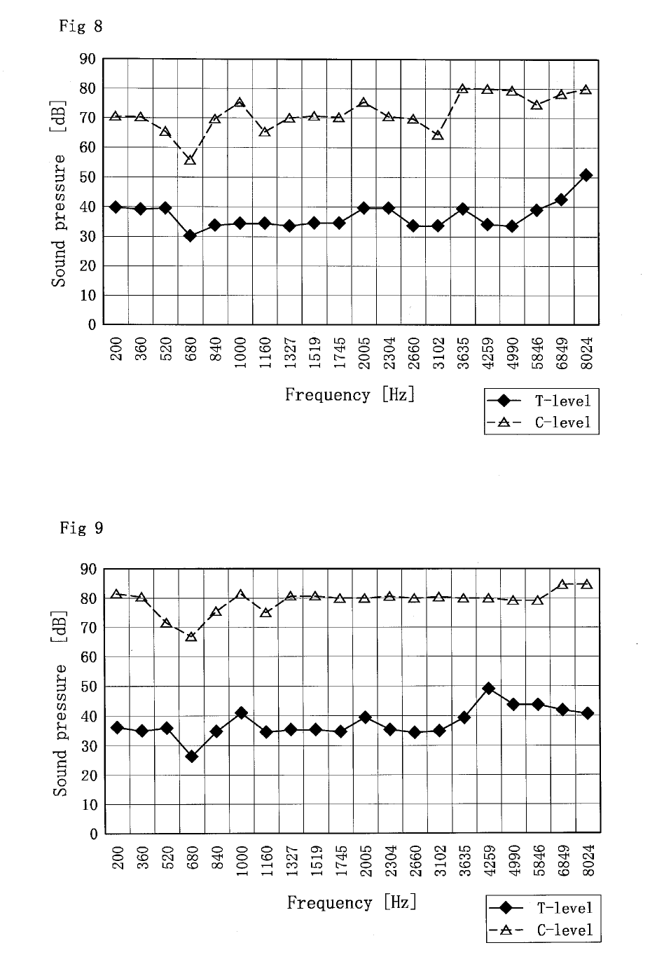

The adjustment (fitting) was performed for wearers “A” and “B” of the two types of the cochlear implants having audio transducing processors. The audiometry step for finding an audible sound range of wearers “A” and “B” using a frequency and a sound pressure as variables was performed, and the audio transducing processors were adjusted on the basis of hearing acuity data obtained from the corresponding audiometry step. The results of these experiments are shown respectively in FIG. 6 (results for wearer “A” and the CSPE-type implant), FIG. 7 (results for wearer “A” and ACE-type implant), FIG. 8 (results for wearer “B” and the CSPE-type implant) and FIG. 9 (results for wearer “B” and the ACE-type implant). In these drawings (FIGS. 6-9), the lower curves show the minimum audible threshold (T-level) and the upper curves show the maximum comfortable threshold (C-level). The results of the experiments shown in FIGS. 6-9 demonstrate that it is possible to measure both the minimum audible threshold (T-level) and the maximum comfortable threshold (C-level) in either implant type and in either wearer, and that loudness equalization is not achieved by prior adjusting methods.

A preferred embodiment of the present invention has been described. Modifications and alternations will occur to those of ordinary skill in the art upon reading and understanding the preceding detailed description. It is intended that the present invention be construed as including all such alternations and modifications insofar as they come within the scope of the appended claims or the equivalents thereof. For example, the present invention can be applied to other types of cochlear implants (e.g., SPEAK type etc.) different from CSPE type or ACE type. For example, the SPEAK-type implant is structured so that it performs the FFT with 2 (ms) overlap as to 8 (ms) frame wave forms inputted from a microphone and selects frequency having a larger power and stimulates an electrode corresponding to the selected frequency. Thus, the number of stimulus electrodes per one frame is eight (8) at most and the number of stimulation is constant in each wearer. In addition, since same number of electrodes are always stimulated, in the SPEAK-type implant, like the ACE-type implant, electrodes must be selected even in a frequency region of weak stimulation. The stimulating rate of one electrode is constant (250 pps) and the total stimulating rate per one frame is 1500 (pps). In some embodiments, a cochlear implant can have a number of the electrodes 6a-6t of the electrode array 6 other than twenty (20).

What is claimed is:

1. A method for adjusting an audio transducing processor provided with a cochlear implant for augmenting audition by giving audio information as stimulus pulses to a cochlea of a wearer, comprising:
an audiometry step for finding an audible sound range of the wearer using frequency and sound pressure as variables, and
adjusting the audio transducing processor on the basis of hearing acuity data obtained from the audiometry step.

2. The method of claim 1, wherein the audio transducing processor adjusts the minimum audible threshold and the maximum comfortable threshold so that they are included within a frequency/sound pressure level necessary for audio perception.

3. The method of claim 2, wherein the minimum audible threshold is an equal loudness level of about 40 phon and the maximum comfortable threshold is an equal loudness level of about 70 phon.
